(19) United States
(12) Patent Application Publication
(10) Pub. No.: US 2026/0065694 A1
(43) Pub. Date: Mar. 5, 2026

(54) EXTERNAL ENVIRONMENT RECOGNITION APPARATUS

(71) Applicant: Honda Motor Co., Ltd., Tokyo (JP)

(72) Inventors: Shunsuke Konishi, Saitama (JP); Daichi Saeki, Saitama (JP); Zao shan Chong, Saitama (JP); Hidetoshi Utsumi, Saitama (JP); Shuhei Masuoka, Utsunomiya-shi (JP)

(21) Appl. No.: 19/313,287

(22) Filed: Aug. 28, 2025

(30) Foreign Application Priority Data
Sep. 4, 2024 (JP) 2024-152437

(51) Int. Cl. G06V 20/56; G01C 21/30; G06T 7/521; G06V 10/75

(52) U.S. Cl. CPC G06V 20/588; G01C 21/30; G06T 7/521; G06V 10/751; G06T 2207/10028; G06T 2207/30256

(57) ABSTRACT

The external environment recognition apparatus includes an in-vehicle detector and a microprocessor. The microprocessor recognizes, as road surface information, a road surface of a road on which a subject vehicle travels and a three-dimensional object thereon, based on point cloud data of each frame acquired by the in-vehicle detector; determines, based on a predetermined size of a predetermined three-dimensional object and a measurement distance from the subject vehicle to the object based on the point cloud data, an interval of detection points for point cloud data of a next frame; and predicts a gradient of an unrecognized road surface based on gradient information associated with map information. The microprocessor determines, for a range from the maximum depth distance to the required depth distance, the interval based on the predetermined size and an estimated distance to the object estimated from the map information and the gradient.

### CROSS-REFERENCE TO RELATED APPLICATION

This application is based upon and claims the benefit of priority from Japanese Patent Application No. 2024-152437 filed on Sep. 4, 2024, the content of which is incorporated herein by reference.

### BACKGROUND OF THE INVENTION

### Field of the Invention

The present invention relates to an external environment recognition apparatus for recognizing an external environment situation of a vehicle.

### Description of the Related Art

As a device of this type, there is known a device that performs scanning by changing emission angles of laser light emitted from a LiDAR about a first axis parallel to a height direction and a second axis parallel to a horizontal direction, and detects an external environment of a vehicle on the basis of position information of each detection point (for example, see JP 2020-149079 A).

In the above device, many detection points are acquired by scanning, and a processing load for acquiring the position information based on each detection point is large.

Detecting an external environment situation of the vehicle enables smooth movement of the vehicle, thereby leading to improvement in traffic convenience and safety. Thus, it is possible to contribute to development of a sustainable transportation system.

### SUMMARY OF THE INVENTION

An aspect of the present invention is an external environment recognition apparatus including an in-vehicle detector configured to perform scanning irradiation of electromagnetic waves in a first direction within a field of view and in a second direction intersecting the first direction, and to acquire, frame by frame, point cloud data including three-dimensional position information of detection points on surfaces of objects around a subject vehicle based on reflected waves from the objects; and a microprocessor. The microprocessor is configured to perform: recognizing, as road surface information, a road surface of a road on which the subject vehicle travels and a three-dimensional object on the road based on the point cloud data of each frame; determining, based on a predetermined size of a predetermined three-dimensional object set as a recognition target and a measurement distance from the subject vehicle to the three-dimensional object based on the point cloud data, an interval of the detection points required for the point cloud data of a next frame; and when a maximum depth distance of the road surface in a traveling direction of the subject vehicle recognized as the road surface is shorter than a required depth distance based on a vehicle speed of the subject vehicle, predicting a gradient of a portion of the road surface that is not recognized, based on gradient information associated with map information in which the road is recorded. When the gradient is predicted, the microprocessor is further configured to determine, for a range from the maximum depth distance to the required depth distance, the interval of the detection points required for the point cloud data of the next frame, based on the predetermined size of the predetermined three-dimensional object and an estimated distance from the subject vehicle to the three-dimensional object estimated from the map information and the gradient.

### BRIEF DESCRIPTION OF THE DRAWINGS

The objects, features, and advantages of the present invention will become clearer from the following description of embodiments in relation to the attached drawings, in which:

FIG. 1A is a diagram illustrating how a vehicle travels on a road;

FIG. 1B is a schematic diagram illustrating an example of detection data obtained by a LiDAR;

FIG. 2 is a block diagram illustrating a configuration of a main part of a vehicle control device;

FIG. 3A is a diagram illustrating a position of point cloud data in a three-dimensional space using a three-dimensional coordinate system;

FIG. 3B is a diagram describing mapping of the point cloud data from the three-dimensional space to a two-dimensional X-Z space;

FIG. 3C is a schematic diagram illustrating the point cloud data divided for each grid;

FIG. 3D is a schematic diagram illustrating a road surface gradient in depth distance direction;

FIG. 4A is a schematic diagram illustrating a light projection angle and a depth distance;

FIG. 4B is a schematic diagram illustrating a distance measured by the LiDAR;

FIG. 5A is a schematic diagram illustrating an example of a relationship between the depth distance and the light projection angle in a vertical direction;

FIG. 5B is a schematic diagram illustrating an example of a relationship between the depth distance and an angular resolution in the vertical direction;

FIG. 6A is a schematic diagram illustrating an example of an irradiation point when the irradiation light of the LiDAR is emitted in a raster scanning method;

FIG. 6B is a schematic diagram illustrating an example of irradiation points in a case where the irradiation light of the LiDAR 5 is emitted only to predetermined lattice points arranged in a lattice pattern in a detection area;

FIG. 7 is a diagram illustrating an example of an irradiation order in a case where the irradiation points illustrated in FIG. 6B are irradiated with the irradiation light;

FIG. 8A is a diagram illustrating an example of example of a prediction;

FIG. 8B is a diagram illustrating another example of example of the prediction;

FIG. 9 is a flowchart illustrating an example of processing executed by a CPU of the controller in FIG. 2; and

FIG. 10 is a flowchart illustrating processing of S20 in FIG. 2;

### DETAILED DESCRIPTION OF THE INVENTION

Hereinafter, embodiments of the present invention will be described with reference to the drawings.

An external environment recognition apparatus according to an embodiment of the invention is applicable to a vehicle having a self-driving capability, that is, a self-driving vehicle. Note that a vehicle to which the external environment recognition apparatus according to the present embodiment is applied is referred to as a subject vehicle in some cases so as to be distinguished from other vehicles. The subject vehicle may be any of an engine vehicle including an internal combustion engine (engine) as a traveling drive source, an electric vehicle including a traveling motor as the traveling drive source, and a hybrid vehicle including an engine and a traveling motor as the traveling drive sources. The subject vehicle is capable of traveling not only in a self-drive mode that does not necessitate the driver's driving operation but also in a manual drive mode of the driver's driving operation.

While a self-driving vehicle is traveling in the self-drive mode (hereinafter, referred to as self-driving or autonomous driving), such a self-driving vehicle recognizes an external environment situation in the surroundings of the subject vehicle, based on detection data of an in-vehicle detector such as a camera or a light detection and ranging (LiDAR). The self-driving vehicle generates a traveling path (a target path) after a predetermined time from the current point in time, based on recognition results, and controls an actuator for traveling so that the subject vehicle travels along the target path.

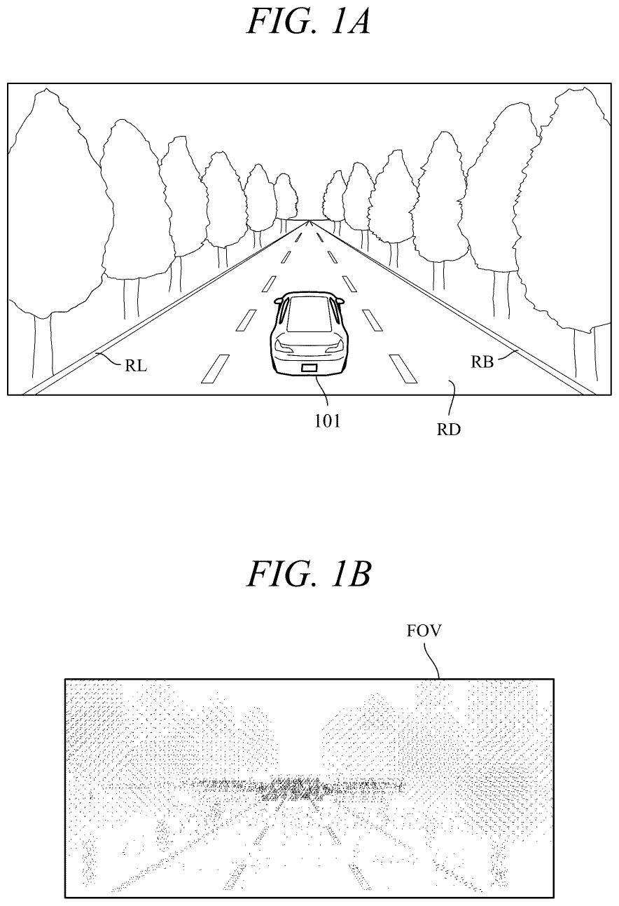

FIG. 1A is a diagram illustrating how a subject vehicle 101, which is a self-driving vehicle, travels on a road RD. FIG. 1B is a schematic diagram illustrating an example of detection data obtained by a LiDAR mounted on the subject vehicle 101 and directed in an advancing direction of the subject vehicle 101. A measurement point (which can also be referred to as a detection point) by the LiDAR is point information of the irradiated laser that has been reflected by a certain one point on a surface of an object and then returned. The point information includes the distance from the laser source to the point, the intensity of the laser reflected and returned, and the relative velocity between the laser source and the point. In addition, data including a plurality of detection points as illustrated in FIG. 1B will be referred to as point cloud data. FIG. 1B illustrates point cloud data based on detection points of surfaces of objects included in the field of view (hereinafter, referred to as FOV) of the LiDAR among the objects in FIG. 1A.

The FOV may be, for example, 120 deg in a horizontal direction (which can be referred to as a road width direction) and 40 deg in a vertical direction (which can be referred to as an up-down direction) of the subject vehicle 101. The value of the FOV may be appropriately changed, based on the specifications of the external environment recognition apparatus. The subject vehicle 101 recognizes an external environment situation in the surroundings of the vehicle, more specifically, a road structure, an object, and the like in the surroundings of the vehicle, based on the point cloud data as illustrated in FIG. 1B, and generates a target path based on the recognition results.

As a method for sufficiently recognizing the external environment situation in the periphery of the vehicle, by the way, it is conceivable to increase the number of irradiation points of electromagnetic waves emitted from the in-vehicle detector such as a LiDAR (in other words, to increase irradiation point density of electromagnetic waves so as to increase the number of detection points constituting the point cloud data). On the other hand, in a case where the number of irradiation points of electromagnetic waves is increased (the number of detection points is increased), there is a possibility that a processing load for controlling the in-vehicle detector increases, a capacity of the detection data (the point cloud data) obtained by the in-vehicle detector increases, and a processing load for the point cloud increases. In particular, in a situation where there are many objects on the road or beside the road, the capacity of the point cloud data further increases.

Hence, in consideration of the above points, in the embodiment, the external environment recognition apparatus is configured as described below.

### <Overview>

The external environment recognition apparatus according to an embodiment intermittently irradiates irradiation light as an example of electromagnetic waves in the advancing direction of the subject vehicle 101 from the LiDAR of the subject vehicle 101, which travels on the road RD, and acquires point cloud data at different positions on the road RD in a discrete manner. The irradiation range of the irradiation light irradiated from the LiDAR is set such that a blank section of data is not generated in the advancing direction of the road RD in the point cloud data of a previous frame that has been acquired by the LiDAR by the previous irradiation and the point cloud data of a next frame to be acquired by the LiDAR by the current irradiation.

By setting the detection point density in the irradiation range, for example, to be higher on the road surface far from the subject vehicle 101 and to be lower on the road surface closer to the subject vehicle 101, the total number of detection points for use in the recognition processing is suppressed, as compared with a case where the high detection point density is set on all the road surfaces in the irradiation range. Thus, it becomes possible to reduce the number of the detection points for use in the recognition processing without lowering the recognition accuracy of the position (the distance from the subject vehicle 101) or the size of an object or the like to be recognized, based on the point cloud data. It is also possible to make the LiDAR smaller and less expensive, for example, by reducing the number of laser elements provided in the LiDAR.

Such an external environment recognition apparatus will be described in more detail.

### <Configuration of Vehicle Control Device>

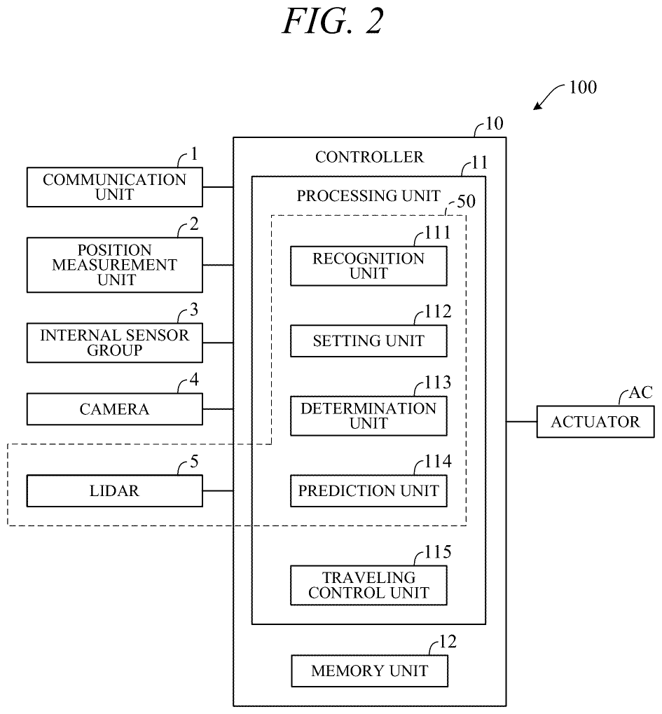

FIG. 2 is a block diagram illustrating a configuration of a substantial part of a vehicle control device 100 including the external environment recognition apparatus. The vehicle control device 100 includes a controller 10, a communication unit 1, a position measurement unit 2, an internal sensor group 3, a camera 4, a LiDAR 5, and a traveling actuator AC. In addition, the vehicle control device 100 includes an external environment recognition apparatus 50, which constitutes a part of the vehicle control device 100. The external environment recognition apparatus 50 recognizes an external environment situation in the surroundings of the vehicle, based on detection data of an in-vehicle detector such as the camera 4 or the LiDAR 5.

The communication unit 1 communicates with various servers, not illustrated, through a network including a wireless communication network represented by the Internet network, a mobile telephone network, or the like, and acquires map information, traveling history information, traffic information, and the like from the servers regularly or at a given timing. The network includes not only a public wireless communication network but also a closed communication network provided for every predetermined management area, for example, a wireless LAN, Wi-Fi (registered trademark), Bluetooth (registered trademark), and the like. The acquired map information is output to a memory unit 12, and the map information is updated. The map information is associated with a road surface gradient map used for predicting the road surface gradient, which will be described in detail later.

The position measurement unit (GNSS unit) 2 includes a position measurement sensor for receiving a position measurement signal transmitted from a position measurement satellite. The position measurement satellite is an artificial satellite such as a GPS satellite or a quasi-zenith satellite. By using the position measurement information that has been received by the position measurement sensor, the position measurement unit 2 measures a current position (latitude, longitude, and altitude) of the subject vehicle 101.

The internal sensor group 3 is a general term of a plurality of sensors (internal sensors) for detecting a traveling state of the subject vehicle 101. For example, the internal sensor group 3 includes a vehicle speed sensor that detects the vehicle speed (the traveling speed) of the subject vehicle 101, an acceleration sensor that detects the acceleration in a front-rear direction and the acceleration in a left-right direction (a lateral acceleration) of the subject vehicle 101, a rotation speed sensor that detects the rotation speed of the traveling drive source, a yaw rate sensor that detects the rotation angular speed about the vertical axis at the center of gravity of the subject vehicle 101, and the like. The internal sensor group 3 also includes sensors that detect a driver's driving operation in the manual drive mode, for example, an operation on an accelerator pedal, an operation on a brake pedal, an operation on a steering wheel, and the like.

The camera 4 includes an imaging element such as a CCD or a CMOS, and captures an image of the surroundings of the subject vehicle 101 (a front side, a rear side, and lateral sides). The LiDAR 5 receives scattered light with respect to the irradiation light, and measures a distance from the subject vehicle 101 to an object in the surroundings, a position and a shape of the object, and the like.

The actuator AC is an actuator for traveling in order to control traveling of the subject vehicle 101. In a case where the traveling drive source is an engine, the actuator AC includes an actuator for throttle to adjust an opening (a throttle opening) of a throttle valve of the engine. In a case where the traveling drive source is a traveling motor, the traveling motor is included in the actuator AC. The actuator AC also includes an actuator for braking that actuates a braking device of the subject vehicle 101, and an actuator for steering that drives a steering device.

The controller 10 includes an electronic control unit (ECU). More specifically, the controller 10 is configured to include a computer including a processing unit 11 such as a CPU (microprocessor), the memory unit 12 such as ROM and RAM, and other peripheral circuits, not illustrated, such as an I/O interface. Note that a plurality of ECUs having different functions such as an ECU for engine control, an ECU for traveling motor control, and an ECU for braking device can be individually provided. However, in FIG. 2, the controller 10 is illustrated as an aggregation of these ECUs for the sake of convenience.

The memory unit 12 can store highly precise detailed map information (referred to as high-precision map information). The high-precision map information includes position information of roads, information of road shapes (curvatures or the like), information of road gradients, position information of intersections and branch points, information of the number of traffic lanes (traveling lanes), information of traffic lane widths and position information for every traffic lane (information of center positions of traffic lanes or boundary lines of traffic lane positions), position information of landmarks (traffic lights, traffic signs, buildings, and the like) as marks on a map, and information of road surface profiles such as irregularities of road surfaces. In addition, other than two-dimensional map information to be described below, the memory unit 12 can also store programs for various types of control, information of thresholds for use in programs, or the like, and setting information (irradiation point information to be described below, and the like) for the in-vehicle detector such as the LiDAR 5.

Note that highly precise detailed map information is not necessarily needed in an embodiment, and the detailed map information may not necessarily be stored in the memory unit 12.

The processing unit 11 includes a recognition unit 111, a setting unit 112, a determination unit 113, a prediction unit 114, and a traveling control unit 115, as functional configurations. Note that, as illustrated in FIG. 2, the recognition unit 111, the setting unit 112, the determination unit 113, and the prediction unit 114 are included in the external environment recognition apparatus 50. As described above, the external environment recognition apparatus 50 recognizes an external environment situation in the periphery of the vehicle on the basis of the detection data of the in-vehicle detector such as the camera 4 or the LiDAR 5. Details of the recognition unit 111, the setting unit 112, the determination unit 113, and the prediction unit 114 included in the external environment recognition apparatus 50 will be described below.

In the self-drive mode, the traveling control unit 115 generates a target path on the basis of the external environment situation in the periphery of the vehicle that has been recognized by the external environment recognition apparatus 50, and controls the actuator AC so that the subject vehicle 101 travels along the target path. Note that in the manual drive mode, the traveling control unit 115 controls the actuator AC in accordance with a traveling command (steering operation or the like) from the driver that has been acquired by the internal sensor group 3.

The LiDAR 5 will be further described.

### <Detection Area>

The LiDAR 5 is attached to face the front side of the subject vehicle 101 so that the FOV includes an area to be observed during traveling. Since the LiDAR 5 receives the light irradiated with the irradiation light and scattered by a three-dimensional object or the like, the FOV of the LiDAR 5 corresponds to the irradiation range of the irradiation light and the detection area. That is, the irradiation point in the irradiation range corresponds to the detection point in the detection area.

In the embodiment, a road surface shape including irregularities, steps, undulations, or the like of a road surface, a three-dimensional object located on the road RD (equipment related to the road RD (a traffic light, a traffic sign, a groove, a wall, a fence, a guardrail, and the like)), an object on the road RD (including other vehicles and an obstacle on the road surface), and a division line provided on the road surface will be referred to as a three-dimensional object or the like. The division line includes a white line (including a line of a different color such as yellow), a curbstone line, a road stud, and the like, and may be referred to as a lane mark. In addition, a three-dimensional object or the like that has been set beforehand as a detection target will be referred to as a detection target.

### <Example of Coordinate System>

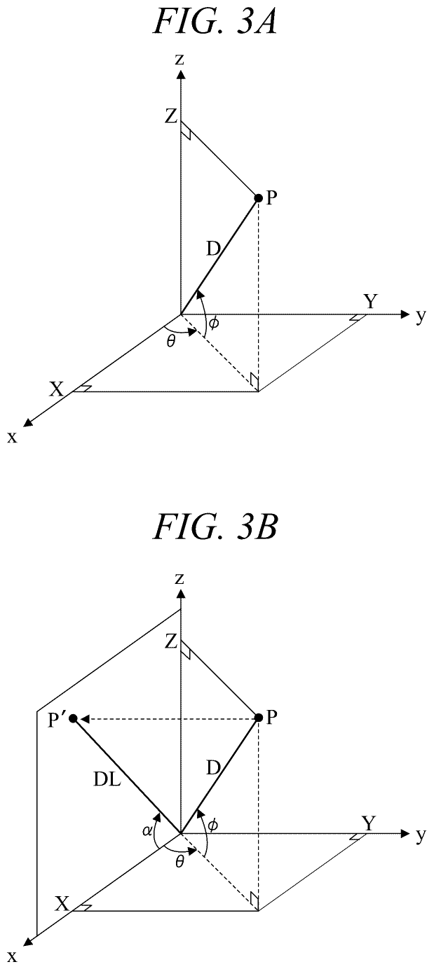

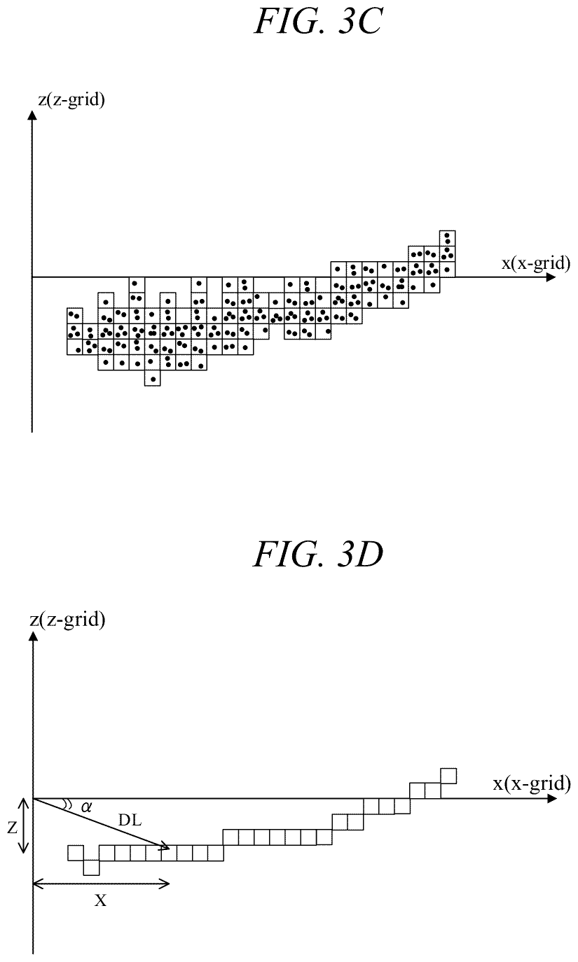

FIG. 3A is a diagram illustrating a position of point cloud data in a three-dimensional space using a three-dimensional coordinate system. In FIG. 3A, an x-axis plus direction corresponds to the advancing direction of the subject vehicle 101, a y-axis plus direction corresponds to a left side in a horizontal direction of the subject vehicle 101, and a z-axis plus direction corresponds to an upper side in a vertical direction.

In addition, an x-axis component of the position of data P will be referred to as a depth distance X, a y-axis component of the position of the data P will be referred to as a horizontal distance Y, and a z-axis component of the position of the data P will be referred to as a height Z.

Assuming that the distance measured by the LiDAR 5, in other words, the distance from the LiDAR 5 to a point on an object as a detection target is set to D, coordinates (X, Y, Z) indicating the position of the data P are calculated by the following formulas.

$$X = D \times cos θ \times cos φ \qquad ( 1 )$$

$$Y = D \times sin θ \times cos φ \qquad ( 2 )$$

$$Z = D \times sin φ \qquad ( 3 )$$

Note that the angle θ will be referred to as a horizontal light projection angle, and the angle φ will be referred to as a vertical light projection angle. The horizontal light projection angle θ and the vertical light projection angle φ are set to the LiDAR 5 by the setting unit 112.

FIG. 3B is a diagram describing mapping of the point cloud data from the three-dimensional space to the two-dimensional X-Z space. In the embodiment, in order to calculate the road surface gradient of the road RD, mapping is performed from the data P in the three-dimensional space to data P′ in the X-Z space for each data constituting the point cloud data. By this mapping, three-dimensional point cloud data is converted into two-dimensional point cloud data in the X-Z space. In the X-Z space, information indicating the horizontal distance Y is omitted, and information of the depth distance X and the height Z remains.

Next, the X-Z space is divided by grids having a predetermined size (for example, 50 cm square), and the number of pieces of data P′ included in each grid is counted. FIG. 3C is a schematic diagram illustrating the point cloud data divided for each grid. Note that the number of grids based on the actual data P′ is much larger than the illustrated number.

FIG. 3C illustrates the position data (depth distance X) for each grid, the height Z for each grid, and the number of pieces of data P′ included in each grid. In the embodiment, since the data of the three-dimensional object is separated and excluded in advance, the data is mainly grid data of X and Z with respect to the data of the road surface. Therefore, by sequentially extracting the grid in which the number of pieces of data P′ in the grid is maximized in the depth distance X direction, a row of grids indicating the height Z of the road surface as illustrated in FIG. 3D, that is, the road surface gradient in the depth distance X direction can be obtained.

When attention is paid to each grid, Formula (4) described below is established between light projection angle α in the vertical direction with respect to the road surface point (corresponding to the irradiation point described above) of the grid, the depth distance X of the road surface point, and the height Z of the road surface. In addition, Formula (5) described below is established between a distance DL from the LiDAR 5 to the road surface point, the depth distance X of the road surface point, and the height Z of the road surface.

$$tan α = Z / X \qquad ( 4 )$$

$$DL = ( X 2 + Z 2 ) 1 / 2 \qquad ( 5 )$$

Note that in the embodiment, it is assumed that the pitch angle, the roll angle, and the yaw angle of a LiDAR 5 installed in a subject vehicle 101 are fixed. In addition, a road surface gradient map described later may be generated on the basis of a road surface gradient (a row of grids indicating a height Z of the road surface described above) acquired by the subject vehicle 101 or by another vehicle provided with the LiDAR 5 in the same manner as the subject vehicle 101, traveling such that a center line of the vehicle width of each vehicle follows a traveling route.

As an example, each vehicle may send data indicating a relationship between the acquired height Z of the road surface on the traveling route and a depth distance X, to an external server device or the like via a communication unit 1 periodically or at an arbitrary timing. The external server device or the like associates, as the road surface gradient map, data indicating a relationship between the average of heights Z of road surface points on the traveling route, which is sent from a plurality of vehicles, and the depth distance X, with two-dimensional map information in which a road RD of the traveling route is recorded.

The external server device or the like may calculate the deviation in height for each road surface point between the average value data of the heights Z of the road surface points on the traveling route newly sent from the plurality of vehicles and the data of the existing road surface gradient map, and update the existing road surface gradient map with the new average value data for an area of the depth distance X where the deviation exceeds a threshold value determined in advance.

Furthermore, instead of associating the road surface gradient map with two-dimensional map information, the external server device or the like may add, to the two-dimensional map information, data indicating the relationship between the average of the heights Z of the road surface points on the traveling route and the depth distance X as one-dimensional height information of each road surface point for each route.

Each vehicle including the subject vehicle 101 may periodically or at an arbitrary timing acquire information on the latest road surface gradient map (or one-dimensional height information for each road surface point) from the external server device or the like via the communication unit 1, and store the information in a memory unit 12.

### <Light Projection Angle and Depth Distance>

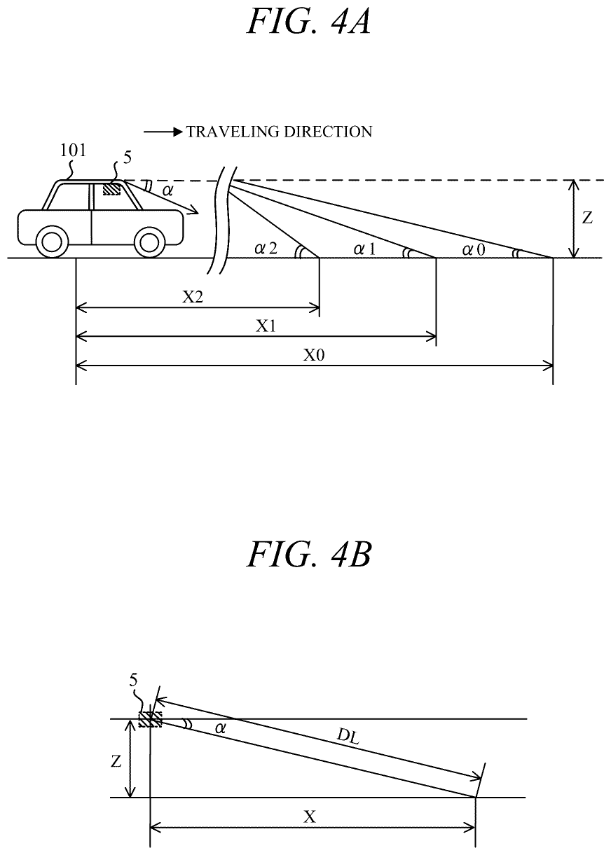

FIG. 4A is a schematic diagram illustrating a light projection angle α in a vertical direction of the LiDAR 5 (an angle of irradiation light with respect to the horizontal direction) and the depth distance X. By changing the light projection angle α, an external environment recognition apparatus 50 vertically changes an irradiation direction of the irradiation light to move a position of an irradiation point in the vertical direction.

In FIG. 4A, in a case where the irradiation light is emitted on the road RD at a location point where a depth distance X2 is 10 m, the road surface is irradiated at a light projection angle α2. In addition, for example, in a case where the irradiation light is emitted on the road RD at a location point where a depth distance X1 is 40 m, the road surface is irradiated at a light projection angle α1. Furthermore, in a case where the irradiation light is emitted on the road RD at a location point where a depth distance X0 is 100 m, the road surface is irradiated at a light projection angle α0.

In general, as the light projection angle with respect to the road surface becomes greater, the scattered light returning from the road surface to the LiDAR 5 becomes smaller. Therefore, in many cases, a reception level of the scattered light with respect to the irradiation light on the location point of the depth distance X0 is the lowest.

FIG. 4B is a schematic diagram illustrating a distance DL measured by the LiDAR 5. As described above with reference to FIGS. 3A to 3D, the external environment recognition apparatus 50 calculates the depth distance X to the road surface point that has been irradiated with the irradiation light and the height Z of the road surface point, by using the light projection angle α set to the LiDAR 5, the distance DL (optical path length of the irradiation light) measured by the LiDAR 5, and Expressions (4) and (5) described above.

The external environment recognition apparatus 50 sets the light projection angle α upward in a case where it is desired to increase the depth distance from a current value, and sets the light projection angle α downward in a case where it is desired to decrease the depth distance from the current value. For example, in a case of changing the depth distance to 100 m from a state in which the irradiation light is emitted on the location point where the depth distance is 70 m, the external environment recognition apparatus 50 sets the light projection angle α upward from the current light projection angle so that the irradiation light is emitted on the location point where the depth distance is 100 m. In addition, for example, in a case where the road RD is a downward gradient or the like and the road RD is not irradiated with the irradiation light, the external environment recognition apparatus 50 sets the light projection angle α downward from the current light projection angle so that the road RD is irradiated with the irradiation light.

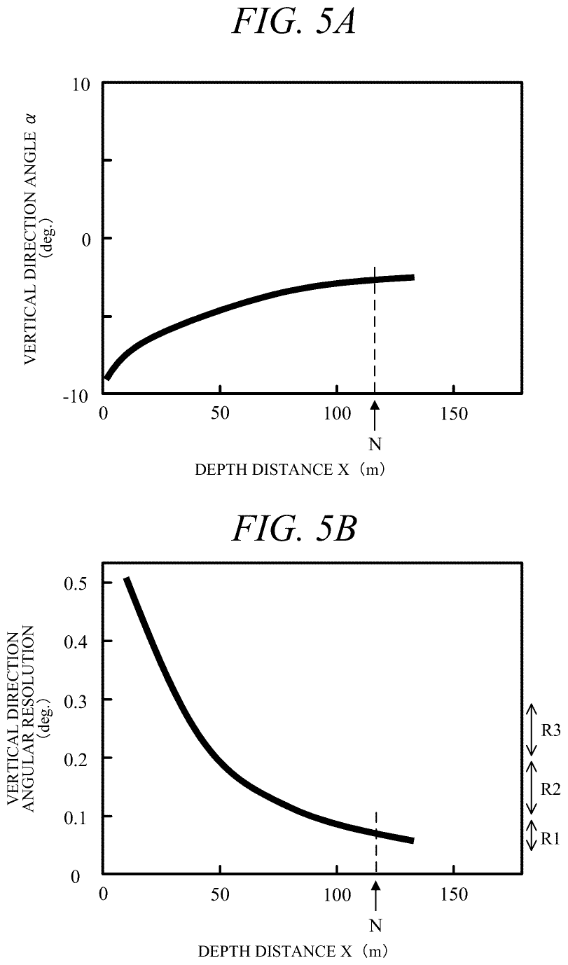

FIG. 5A is a schematic diagram illustrating an example of a relationship between the depth distance X and the light projection angle α in the vertical direction. The horizontal axis represents the depth distance X (unit: m), and the vertical axis represents the light projection angle α (unit: deg) in the vertical direction. The light projection angle α can be referred to as a vertical direction angle. As illustrated in FIG. 5A, the external environment recognition apparatus 50 sets the light projection angle α downward from the current light projection angle in a case where it is desired to decrease the depth distance X, and sets the light projection angle α upward from the current light projection angle in a case where it is desired to increase the depth distance X. Reference sign N will be described below.

### <FOV and Depth Distance>

In the embodiment, a road surface situation from the depth distance (for example, X2 in FIG. 4A) corresponding to a lower end of the FOV of the LiDAR 5 to the depth distance (for example, X0 in FIG. 4A) corresponding to an upper end of the FOV is detected. The depth distance corresponding to the lower end of the FOV will be referred to as a first predetermined distance, and the depth distance corresponding to the upper end of the FOV will be referred to as a second predetermined distance.

In general, a camera 4 is superior to the LiDAR 5 in terms of resolution at short distances, and the LiDAR 5 is superior to the camera 4 in terms of distance measurement accuracy and relative speed measurement accuracy. Therefore, in a case where the angle of view of the camera 4 is wider in the vertical direction than the FOV of the LiDAR 5, the external environment recognition apparatus 50 may cause the camera 4 to detect the road surface situation for a lower side of the lower end of the FOV of the LiDAR 5 (in other words, a road surface close to the subject vehicle 101).

### <Number of Irradiation Points of Irradiation Light>

The external environment recognition apparatus 50 calculates the position of the irradiation point to be irradiated with the irradiation light of the LiDAR 5 within the FOV of the LiDAR 5. More specifically, the external environment recognition apparatus 50 calculates the irradiation point in accordance with an angular resolution to be calculated on the basis of a minimum size (for example, 15 cm in both vertical direction and horizontal direction) of a three-dimensional object, which is designated in advance as a detection target (may be referred to as a recognition target), and a required depth distance (for example, 100 m). The three-dimensional object is, for example, a stone or a concrete piece on a road. The required depth distance corresponds to a braking distance of the subject vehicle 101, which is changed depending on the vehicle speed.

In the embodiment, based on the idea that the road surface situation of the road in the traveling direction of the traveling subject vehicle 101 is to be detected at least beyond the braking distance, a value obtained by adding a predetermined margin to the braking distance will be referred to as the required depth distance. The vehicle speed of the subject vehicle 101 is detected by a vehicle speed sensor of an internal sensor group 3. The relationship between the vehicle speed and the required depth distance is stored in advance in the memory unit 12. Reference sign N in FIG. 5A indicates the required depth distance in a case where the vehicle speed is, for example, 100 km/h.

As an example of the angular resolution in a case where a detection target of 15 cm at a distance of 100 m is detected as the required depth distance, 0.05 deg is required in each of the vertical direction and the horizontal direction as described below with reference to FIG. 5B. Note that in a case where a detection target having a smaller size than 15 cm is detected, and in a case where a detection target of 15 cm at the depth distance X longer than 100 m is detected, it is necessary to further increase the number of irradiation points within the FOV by increasing the angular resolution.

For example, the external environment recognition apparatus 50 calculates the positions of the irradiation points to be arranged in a lattice pattern within the FOV, and aligns the intervals of the lattice points in the vertical direction and the horizontal direction with the angular resolution in the vertical direction and the horizontal direction, respectively. In a case of increasing the angular resolution in the vertical direction, the FOV is divided in the vertical direction by the number based on the angular resolution, and the lattice interval in the vertical direction is narrowed to increase the number of irradiation points. In other words, the interval of the irradiation points is made dense. On the other hand, in a case of decreasing the angular resolution in the vertical direction, the FOV is divided in the vertical direction by the number based on the angular resolution, and the lattice interval in the vertical direction is widened to decrease the number of irradiation points. In other words, the interval of the irradiation points is made coarser. The same applies to the horizontal direction.

The external environment recognition apparatus 50 generates information (hereinafter, referred to as irradiation point information) indicating the position of the irradiation point that has been calculated in accordance with the angular resolution, and stores, in the memory unit 12, the information in association with the position information indicating the current traveling position of the subject vehicle 101.

### <Angular Resolution and Depth Distance>

FIG. 5B is a schematic diagram illustrating an example of the relationship between the depth distance X and the angular resolution in the vertical direction, and illustrates the angular resolution (also referred to as required angular resolution) required for recognizing the detection target having the above-described size (15 cm both vertically and horizontally). The horizontal axis represents the depth distance X (unit: m), and the vertical axis represents the angular resolution (unit: deg) in the vertical direction. In general, as the depth distance X is decreased (in other words, the detection target is closer to the subject vehicle 101), the viewing angle with respect to the detection target is increased, and thus, it is possible to detect the detection target even when the angular resolution is low. On the other hand, as the depth distance X is increased (in other words, the detection target is far from the subject vehicle 101), the viewing angle with respect to the detection target is decreased, and thus a high angular resolution is required for detecting the detection target. For this reason, as illustrated in FIG. 5B, the external environment recognition apparatus 50 decreases the angular resolution (increases the value of the angular resolution) as the depth distance X is decreased, and increases the angular resolution (decreases the value of the angular resolution) as the depth distance X is increased.

Note that although not illustrated, the same applies to the relationship between the depth distance X and the angular resolution in the horizontal direction.

Reference sign Nin FIG. 5B indicates the required depth distance in a case where the vehicle speed is, for example, 100 km/h.

When the subject vehicle 101 is traveling in a self-drive mode, the external environment recognition apparatus 50 controls the LiDAR 5 to set predetermined irradiation points (detection points) within the FOV and to emit the irradiation light. Thus, the irradiation light from the LiDAR 5 is emitted toward the set irradiation point (detection point).

Note that the irradiation light of the LiDAR 5 may be emitted to all irradiation points (detection points) arranged in the lattice pattern within the FOV in a raster scanning method, or the irradiation light may be intermittently emitted such that the irradiation light is emitted to only predetermined irradiation points (detection points), or may be emitted in other manners.

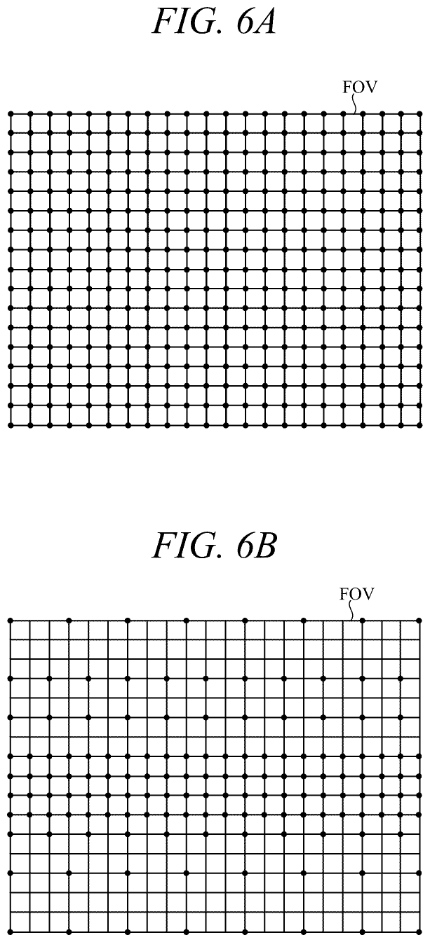

FIG. 6A is a schematic diagram illustrating an example of irradiation points in a case where the irradiation light of the LiDAR 5 is emitted in the raster scanning method. When emitting the irradiation light from the LiDAR 5, the external environment recognition apparatus 50 sets the angular resolution required at a required depth distance N for the entire area within the FOV, and controls the irradiation direction of the irradiation light.

For example, in a case where the required angular resolution for recognizing the detection target present at a location point of the required depth distance N on the road RD is 0.05 deg both vertically (in the vertical direction) and horizontally (in the horizontal direction), the external environment recognition apparatus 50 controls the irradiation direction of the irradiation light to be shifted at an interval of 0.05 deg vertically and horizontally in the entire area within the FOV. That is, in FIG. 6A, each black circle at the lattice point corresponds to the irradiation point (detection point), and the vertical and horizontal intervals of the irradiation points (detection points) correspond to the angular resolution of 0.05 deg.

The number of actual irradiation points within the FOV is much greater than the number of black circles illustrated in FIG. 6A. As a specific example, in a case where the FOV of the LiDAR 5 is 120 deg in the horizontal direction, 2400 black circles corresponding to the irradiation points (detection points) are arranged at an interval of 0.05 deg in the horizontal direction. Similarly, in a case where the FOV is 40 deg in the vertical direction, 800 black circles corresponding to the irradiation points (detection points) are arranged at an interval of 0.05 deg in the vertical direction.

The external environment recognition apparatus 50 acquires detection data of the detection points corresponding to the irradiation points in FIG. 6A each time a scan of the irradiation light for one frame is performed with respect to the FOV, and extracts data of the detection points based on the angular resolution required for the recognition of the detection target from these pieces of detection data. More specifically, for an area in the FOV in which the depth distance X is shorter than the required depth distance N and the required angular resolution of 0.1 deg is sufficient instead of 0.05 deg, data is extracted such that the vertical and horizontal data intervals are wider than the interval of 0.05 deg. In addition, also for an area in the FOV corresponding to the sky, the road RD is not present, and thus data is extracted so as to widen the vertical and horizontal data intervals. The interval of the detection points extracted in this manner is similar to the interval of the detection points indicated by black circles in FIG. 6B to be described below.

The external environment recognition apparatus 50 extracts the data of the detection points, thereby enabling the total number of pieces of detection data used for the recognition processing to be suppressed.

FIG. 6B is a schematic diagram illustrating an example of irradiation points in a case where the irradiation light of the LiDAR 5 is emitted to only the predetermined irradiation points (detection points) arranged in the lattice pattern within the FOV. When the irradiation light is emitted from the LiDAR 5, the external environment recognition apparatus 50 sets the interval of irradiation points (detection points) within the FOV to an interval corresponding to the required angular resolution, and controls the irradiation direction of the irradiation light.

For example, in a case where the required angular resolution for recognizing the detection target present at a location point of the required depth distance N on the road RD is 0.05 deg both vertically (in the vertical direction) and horizontally (in the horizontal direction), the external environment recognition apparatus 50 controls the irradiation direction of the irradiation light to be shifted at an interval of 0.05 deg vertically and horizontally in the area (a band-shaped area that is long in a left-right direction) corresponding to the required depth distance N.

In addition, for an area within the FOV in which the depth distance X is shorter than the required depth distance N and the required angular resolution of 0.1 deg is sufficient, the irradiation direction of the irradiation light is controlled to widen the vertical and horizontal intervals of the detection points. Furthermore, also for an area within the FOV corresponding to the sky, the road RD is not present, and thus the irradiation direction of the irradiation light is controlled to widen the vertical and horizontal intervals of the detection points. As an example, at the beginning of the irradiation, the irradiation is started in a coarse-density distribution of the irradiation points (detection points) in a state where the road surface is flat or in a state where the measurement was performed last time.

The external environment recognition apparatus 50 controls the interval of the detection points (in other words, controls the interval (coarse-density state) of the irradiation points at the time of scanning irradiation), thereby enabling the total number of pieces of detection data used for the recognition processing to be suppressed.

Note that the number of actual irradiation points within the FOV is much greater than the number of black circles illustrated in FIG. 6B.

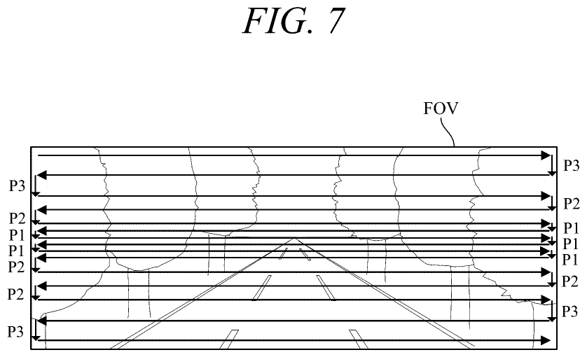

FIG. 7 is a diagram illustrating an example of an irradiation order in a case where the irradiation points illustrated in FIG. 6B are irradiated with the irradiation light. In FIG. 7, the irradiation directions of the irradiation light are respectively controlled in directions of arrows from upper left irradiation points to lower right irradiation points of the FOV. In addition, characters P1 to P3 written together with vertical arrows indicate the magnitude of the intervals of the irradiation points (detection points), and P1 indicates, for example, an interval of the irradiation points (detection points) corresponding to an angular resolution of 0.05 deg. P2 indicates, for example, an interval of the irradiation points (detection points) corresponding to an angular resolution of 0.1 deg. P3 indicates, for example, an interval of the irradiation points (detection points) corresponding to an angular resolution of 0.2 deg.

FIG. 7 illustrates an example in which the angular resolution is switched in three stages. However, the angular resolution may be configured to be appropriately switched in two or more stages without being limited to the three stages. For example, the angular resolution may be switched in four stages by adding an interval P4 of the irradiation points (detection points) corresponding to an angular resolution of 0.3 deg in addition to the intervals P1, P2, and P3 of the irradiation points (detection points).

### <Configuration of External Environment Recognition Apparatus>

Details of the external environment recognition apparatus 50 will be described.

As described above, the external environment recognition apparatus 50 includes a recognition unit 111, a setting unit 112, a determination unit 113, a prediction unit 114, and the LiDAR 5.

### <Recognition Unit>

The recognition unit 111 generates three-dimensional point cloud data using time-series detection data detected in the FOV of the LiDAR 5.

In addition, the recognition unit 111 recognizes a road structure in the traveling direction of the road RD on which the subject vehicle 101 travels, and a detection target on the road RD in the traveling direction on the basis of the detection data measured by the LiDAR 5. The road structure refers to, for example, a straight road, a curved road, a branch road, an entrance or exit of a tunnel, or the like.

Furthermore, for example, by performing luminance filtering processing or the like on data indicating a flat road surface, the recognition unit 111 senses a division line. In this case, in a case where the height of the road surface where the luminance exceeds a predetermined threshold value is substantially the same as the height of the road surface where the luminance does not exceed the predetermined threshold value, the recognition unit 111 may determine that it is a division line.

### <Recognition of Road Structure>

An example of recognition of the road structure by the recognition unit 111 will be described. The recognition unit 111 recognizes, as boundary lines RL and RB (FIG. 1A) of the road RD, a curbstone, a wall, a groove, a guardrail, or a division line of the road RD on a forward side, which is the traveling direction, included in the generated point cloud data, and recognizes a road structure in the traveling direction indicated by the boundary lines RL and RB. As described above, the division line includes a white line (including a line in a different color), a curbstone line, a road stud, or the like, and a traveling lane of the road RD is defined by markings with these division lines. In the embodiment, the boundary lines RL and RB of the road RD defined by the above markings will be referred to as division lines.

The recognition unit 111 recognizes an area interposed between the boundary lines RL and RB, as an area corresponding to the road RD. Note that a recognition method for recognizing the road RD is not limited to this, and the road RD may be recognized in another method.

In addition, the recognition unit 111 separates the generated point cloud data into point cloud data indicating a flat road surface and point cloud data indicating a three-dimensional object or the like. For example, among three-dimensional objects or the like on the road in the traveling direction included in the point cloud data, road surface shapes such as irregularities, steps, and undulations that exceed 15 cm in size and objects that exceed 15 cm both vertically and horizontally are recognized as the detection target. 15 cm is an example of a size of the detection target, and the size of the detection target may be appropriately changed.

### <Setting Unit>

The setting unit 112 sets a vertical light projection angle φ of the irradiation light to the LiDAR 5. In a case where the FOV of the LiDAR 5 is 40 deg in the vertical direction, the vertical light projection angle φ is set in a range of 0 to 40 deg at an interval of 0.05 deg. Similarly, the setting unit 112 sets a horizontal light projection angle θ of the irradiation light to the LiDAR 5. In a case where the FOV of the LiDAR 5 is 120 deg in the horizontal direction, the horizontal light projection angle θ is set in a range of 0 to 120 deg at an interval of 0.05 deg.

The setting unit 112 sets the number of irradiation points (corresponding to the number of black circles in FIGS. 6A and 6B and indicating the irradiation point density) within the FOV to the LiDAR 5 on the basis of the angular resolution determined by the determination unit 113 as will be described below. As described above, the intervals in the vertical direction and the horizontal direction of the irradiation points (detection points) arranged in the lattice pattern within the FOV are respectively caused to correspond to the angular resolutions in the vertical direction and the horizontal direction.

### <Determination Unit>

The determination unit 113 determines a scanning angular resolution set by the setting unit 112. First, the determination unit 113 calculates each of the light projection angle α in the vertical direction at each depth distance X and the distance DL to the road surface point at each depth distance X. Specifically, as described with reference to FIG. 3D, the depth distance X is calculated on the basis of the distance DL to the road surface point measured by the LiDAR 5 and the light projection angle α set in the LiDAR 5 at the time of measurement. The determination unit 113 calculates a relationship between the calculated depth distance X and the vertical direction angle (FIG. 5A). In addition, the determination unit 113 calculates a relationship between the depth distance X and the distance DL. Furthermore, as illustrated in FIG. 5B, the determination unit 113 calculates a relationship between the depth distance X and the angular resolution in the vertical direction, on the basis of the size of the detection target and the depth distance X. In this manner, the angular resolution in the vertical direction is calculated on the basis of the size of the detection target and the distance DL, and the relationship between the depth distance X and the angular resolution in the vertical direction is calculated on the basis of the distance DL and the depth distance X.

Next, the determination unit 113 determines an angular resolution in the vertical direction required for recognizing the detection target having the above-described size. For example, for the depth distance X at which the angular resolution in the vertical direction is smaller than 0.1 deg in FIG. 5B, 0.05 deg, which is smaller than 0.1 deg, is determined as the required angular resolution. In addition, for the depth distance X at which the angular resolution in the vertical direction is equal to or greater than 0.1 deg and smaller than 0.2 deg, 0.1 deg, which is smaller than 0.2 deg, is determined as the required angular resolution. Similarly, for the depth distance X at which the angular resolution in the vertical direction is equal to or greater than 0.2 deg and smaller than 0.3 deg and the depth distance X at which the angular resolution in the vertical direction is equal to or greater than 0.3 deg and smaller than 0.4 deg, 0.2 deg and 0.3 deg, which are smaller than 0.3 deg and 0.4 deg, respectively, are determined as the required angular resolutions.

The determined required angular resolution in the vertical direction can be reflected as an interval in the vertical direction between detection points when three-dimensional point cloud data for the next frame is acquired.

In addition, the determination unit 113 may determine the required angular resolution in the horizontal direction for recognizing the detection target, in accordance with the size of the detection target and the depth distance X. The required angular resolution in the horizontal direction can also be reflected as an interval in the horizontal direction between the detection points when the three-dimensional point cloud data of the next frame is acquired.

Note that the required angular resolution in the horizontal direction may be made to match the required angular resolution in the vertical direction that has been determined previously. In other words, on the same horizontal line as the detection point at which the required angular resolution in the vertical direction has been determined to be 0.05 deg, the required angular resolution in the horizontal direction is determined to be 0.05 deg. Similarly, on the same horizontal line as the detection point at which the required angular resolution in the vertical direction has been determined to be 0.1 deg, the required angular resolution in the horizontal direction is determined to be 0.1 deg. Furthermore, for other required angular resolutions, on the same horizontal line as the detection point at which the required angular resolution in the vertical direction has been determined, the required angular resolution in the horizontal direction is determined to be the same value as the required angular resolution in the vertical direction.

### <Prediction Unit>

For example, when the road surface of the road RD on which the subject vehicle 101 travels becomes flooded with rainwater or the like, the LiDAR 5 may be unable to receive scattered light up to the required depth distance N. In such a case, the farthest depth distance X that can be detected by the LiDAR 5 is referred to as a maximum depth distance L. The maximum depth distance may be referred to as a maximum road surface detection distance. Note that even in a case where the road surface of the road RD is a downhill slope in the traveling direction, or in a case where the vehicle speed of the subject vehicle 101 is high and the required depth distance N is long, the LiDAR 5 may also be unable to receive scattered light up to the required depth distance N.

In a case where the required depth distance N calculated from the vehicle speed of the subject vehicle 101 exceeds the maximum depth distance L (for example, in a case where the required depth distance N is 115 m and the maximum depth distance L is 80 m), the prediction unit 114 predicts the height Z (road surface gradient) of the road surface from the maximum depth distance L to the required depth distance N by using the above-described road surface gradient map.

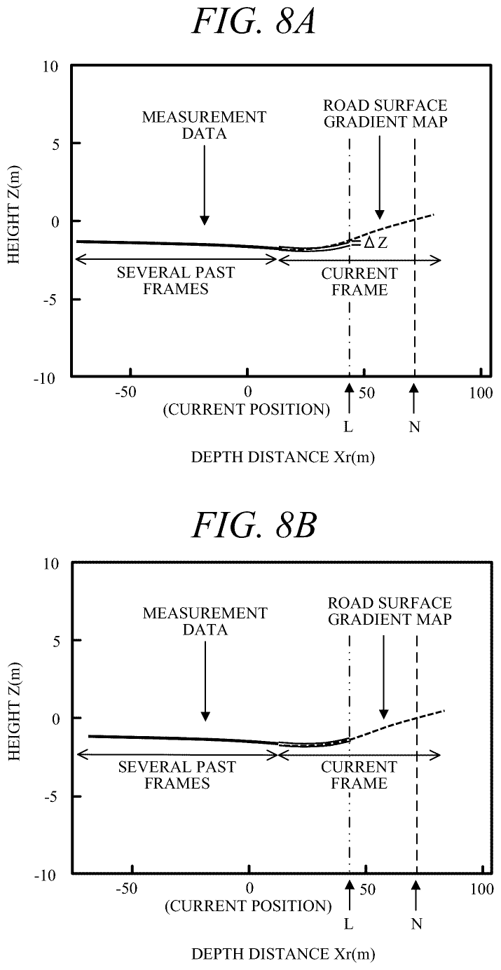

An example of the prediction will be described with reference to FIGS. 8A and 8B. FIGS. 8A and 8B are two-dimensional graphs illustrating a relationship between a depth distance Xr on the traveling route and the height Z of the road surface, the horizontal axis represents the depth distance Xr (unit: m) and the vertical axis represents the height Z (unit: m) of the road surface. The scale on the horizontal axis is indicated with negative values on the side of the subject vehicle 101 from the current position and positive values on the depth side from the current position, by using the current position of the subject vehicle 101 as a reference.

The prediction unit 114 performs alignment between the height Z of the road surface measured by the LiDAR 5 and the road surface gradient map associated with the map information. More specifically, with respect to the point cloud data represented based on the position of the subject vehicle 101 acquired using a position measurement unit 2, in the two-dimensional graph of the depth distance Xr and the height Z on the traveling route, the position on the Xr axis is adjusted by relatively shifting the road surface gradient map forward or backward on the Xr axis so that the deviation ΔZ between an actual measurement result (measurement data based on the point cloud data) of the height Z of the road surface and the height Z of the road surface from the road surface gradient map is minimized.

In FIG. 8A, in the measurement data indicating the height Z of the road surface measured by the LiDAR 5, a range (indicated by a solid line) from several tens of meters on the negative side to several tens of meters (for example, 10 m) on the positive side relative to the subject vehicle 101 represents the height Z of the road surface based on the point cloud data of several past frames measured sequentially over time by the LiDAR 5. In addition, a range (indicated by a double line) from several tens of meters (for example, 10 m) on the positive side to the maximum depth distance L beyond the solid-line display represents the height Z of the road surface based on the point cloud data of the current frame (the newly acquired frame). Furthermore, the data indicated by a dashed line represents the height Z of the road surface according to the road surface gradient map.

In general, in a case where an error is included in the current position of the subject vehicle 101 acquired using the position measurement unit 2, the positions of the measurement data on the traveling route and the road surface gradient map do not align, and thus, the actual measurement result (indicated by a solid line or double line) of the height Z of the road surface and the height Z (indicated by a dashed line) of the road surface from the road surface gradient map do not match, resulting in the deviation ΔZ in the height direction.

As an example of suppressing the deviation ΔZ, the prediction unit 114 searches for a position where the sum of least squares based on the magnitude of the deviation ΔZ is minimized, while shifting the data (indicated by a dashed line) of the road surface gradient map along the Xr axis so as to align the data of the road surface gradient map with the data (indicated by a double line) for a predetermined section (for example, 5 m to 10 m) of the height Z (measurement data) of the road surface based on the point cloud data of the current frame, and then relatively shifts the road surface gradient map to that position.

As illustrated in FIG. 8B, after the position of the road surface gradient map with respect to the current position of the subject vehicle 101 is relatively shifted on the Xr axis, the actual measurement result (indicated by a solid line or double line) of the height Z of the road surface and the height Z (indicated by a dashed line) of the road surface from the road surface gradient map match, and the deviation ΔZ in the height direction is suppressed to a value equal to or less than a predetermined value.

As described above, by shifting the data of the road surface gradient map in FIG. 8A forward and backward along the depth distance Xr axis on the traveling route, it is possible to align the position of the road surface gradient map with the position of the subject vehicle 101 (FIG. 8B).

### <Generation of Position Data>

The external environment recognition apparatus 50 is capable of generating continuous position data by mapping data indicating positions of detection targets detected on the basis of time-series point cloud data measured in real time by the LiDAR 5, for example, on an X-Y two-dimensional map. In an X-Y space, information indicating the height Z is omitted, and information of the depth distance X and the horizontal distance Y remains.

The recognition unit 111 acquires the position information of the three-dimensional object or the like on the two-dimensional map stored in the memory unit 12, and calculates a relative position of the three-dimensional object or the like through coordinate conversion with the position of the subject vehicle 101 as the center, from a moving speed and a moving direction (for example, an azimuth angle) of the subject vehicle 101. Whenever point cloud data is acquired by the LiDAR 5 by measurement, the recognition unit 111 converts a relative position of a three-dimensional object or the like based on the acquired point cloud data into coordinates with the position of the subject vehicle 101 as the center, and records the coordinates of the relative position of a three-dimensional object or the like on a two-dimensional map.

### <Description of Flowchart>

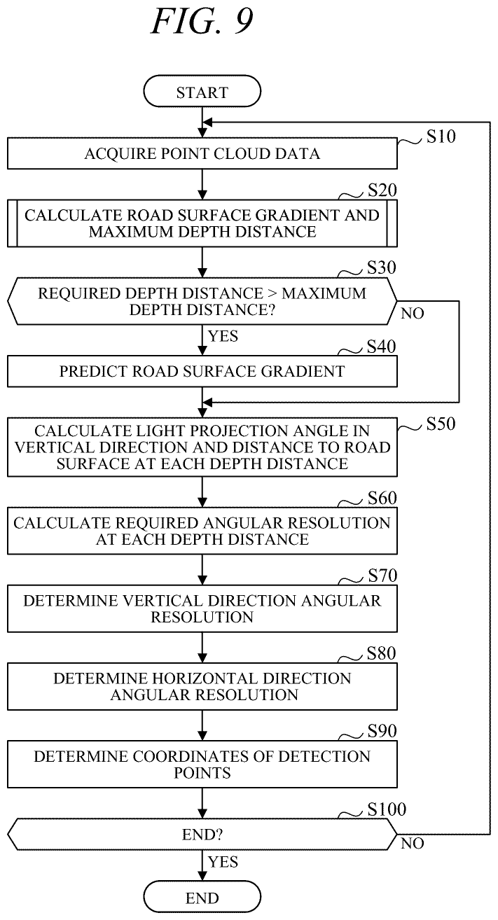

FIG. 9 is a flowchart illustrating an example of processing executed by a processing unit 11 of a controller 10 in FIG. 2 in accordance with a predetermined program. The processing illustrated in the flowchart of FIG. 9 is repeated, for example, every predetermined cycle while the subject vehicle 101 is traveling in the self-drive mode.

First, in step S10, the processing unit 11 causes the LiDAR 5 to acquire three-dimensional point cloud data, and the processing proceeds to step S20.

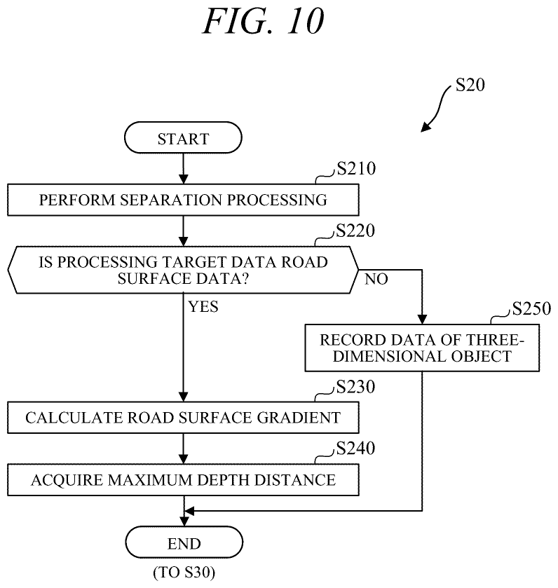

In step S20, the processing unit 11 calculates the road surface gradient in the traveling direction of the road RD and the maximum depth distance L on the basis of the point cloud data acquired by the LiDAR 5, and the processing proceeds to step S30. Details of the processing in step S20 will be described below with reference to FIG. 10.

In step S30, the prediction unit 114 of the processing unit 11 determines whether or not the maximum depth distance L is shorter than the required depth distance N. In a case where the maximum depth distance L is shorter than the required depth distance N, the processing unit 11 makes an affirmative determination in step S30 and the processing proceeds to step S40, and in a case where the maximum depth distance L is longer than the required depth distance N, the processing unit 11 makes a negative determination in step S30 and the processing proceeds to step S50.

In step S40, the prediction unit 114 of the processing unit 11 predicts the road surface gradient from the maximum depth distance L to the required depth distance N, and the processing proceeds to step S50. An example of a prediction result of the road surface gradient is as illustrated in FIG. 8B.

In step S50, the processing unit 11 calculates the light projection angle α in the vertical direction and the distance DL to the road surface point at each depth distance X, and the processing proceeds to step S60. The relationship between the vertical direction angle and the depth distance X is as illustrated in FIG. 5A. In addition, the relationship between the depth distance X, the height Z of the road surface, and the distance DL to the road surface is as illustrated in FIG. 4B.

In step S60, the processing unit 11 calculates the required angular resolution at each depth distance X, and the processing proceeds to step S70. The required angular resolution is an angular resolution required for detecting a detection target having a size designated in advance. The relationship between the depth distance X and the angular resolution is as illustrated in FIG. 5B.

In step S70, the processing unit 11 causes the determination unit 113 to determine the angular resolution in the vertical direction as the required angular resolution, and the processing proceeds to step S80. In the embodiment, the angular resolution in the vertical direction is determined prior to the angular resolution in the horizontal direction.

In step S80, the determination unit 113 of the processing unit 11 determines the angular resolution in the horizontal direction as the required angular resolution, and the processing proceeds to step S90. By determining the angular resolution in the horizontal direction after the angular resolution in the vertical direction, it becomes easy to make the angular resolution in the horizontal direction match the angular resolution in the vertical direction.

In step S90, the processing unit 11 determines the coordinates of the detection points. More specifically, coordinates indicating the positions of the detection points as exemplified by the black circles in FIG. 6B are determined. The recognition unit 111 recognizes a three-dimensional object or the like in the traveling direction of the road RD on which the subject vehicle 101 travels, on the basis of the detection data detected at the positions of the detection points determined in step S90.

Note that whenever the point cloud data is acquired in step S10, the processing unit 11 maps the relative position of the three-dimensional object or the like based on the point cloud data, on the X-Y two-dimensional map, and generates position data that is continuous in a two-dimensional manner. Then, the relative position of the three-dimensional object or the like based on the point cloud data can be converted into the coordinates with the position of the subject vehicle 101 as the center, and the coordinates can be recorded on the two-dimensional map.

In step S100, the processing unit 11 determines whether to end the processing. In a case where the subject vehicle 101 is continuously traveling in the self-drive mode, the processing unit 11 makes a negative determination in step S100, the processing returns to step S10, and the above-described processing is repeated. By returning to step S10, the measurement of the three-dimensional object or the like based on the point cloud data is periodically and repeatedly performed while the subject vehicle 101 is traveling. On the other hand, in a case where the subject vehicle 101 has finished traveling in the self-drive mode, the processing unit 11 makes an affirmative determination in step S100, and ends the processing of FIG. 9.

FIG. 10 is a flowchart for describing details of the processing of step S20 (FIG. 9) executed by the processing unit 11. The processing unit 11 performs processing according to FIG. 10 on the point cloud data of the detection points determined by the determination unit 113.

In step S210, the processing unit 11 performs separation processing on the point cloud data, and the processing proceeds to step S220. More specifically, data of the three-dimensional object or the like on the road RD is detected and separated from the point cloud data, and point cloud data indicating a flat road surface and point cloud data indicating the three-dimensional object or the like are obtained. The three-dimensional object or the like includes, for example, an obstacle on a road, a curbstone, a wall, a groove, a guardrail, and the like provided at the left and right ends of the road RD, and in addition, other vehicles such as a motorcycle that is traveling.

An example of the separation processing will be described. The processing unit 11 converts the coordinates of the relative position of the point cloud data with the position of the subject vehicle 101 as the center, indicates the road RD on the X-Y two-dimensional map corresponding to a depth direction and a road width direction, for example, as viewed from above, and forms the two-dimensional map into grids having a predetermined size. In a case where the difference between the maximum value and the minimum value of the data in the grid in each grid is smaller than a predetermined threshold value, the processing unit 11 determines that the data of the grid indicates a flat road surface. On the other hand, in a case where the difference between the maximum value and the minimum value of the data in the grid is greater than the predetermined threshold value, the processing unit 11 determines that the data of the grid indicates a three-dimensional object or the like.

Note that as a method of determining whether or not the point cloud data corresponds to the data of the road surface or the three-dimensional object or the like, another method may be used.

In step S220, the processing unit 11 determines whether or not processing target data is the data of the road surface. In a case where the data is data of the grid separated as the data of the road surface, the processing unit 11 makes an affirmative determination in step S220 and the processing proceeds to step S230. On the other hand, in a case where the data is data of the grid separated as the data of the three-dimensional object or the like, the processing unit 11 makes a negative determination in step S220 and the processing proceeds to step S250.

In a case where the processing proceeds to step S250, the recognition unit 111 of the processing unit 11 converts the coordinates of the relative position of the three-dimensional object or the like based on the point cloud data of the grid with the position of the subject vehicle 101 as the center, and records the coordinates on the two-dimensional map. Then, the processing in FIG. 10 ends, and the processing proceeds to step S30 in FIG. 9.

In a case where the processing proceeds to step S230, the prediction unit 114 of the processing unit 11 calculates the road surface gradient of the road RD. An example of the calculation processing of the road surface gradient is as described with reference to FIGS. 3A to 3D.

Note that as the calculation method of the road surface gradient, another method may be used.

In step S240, the prediction unit 114 of the processing unit 11 acquires the maximum depth distance L, and ends the processing in FIG. 10, and the processing proceeds to step S30 in FIG. 9.

As described above, the maximum depth distance Lis the farthest depth distance that can be detected by the LiDAR 5. The prediction unit 114 of the processing unit 11 acquires, as the maximum depth distance L, the depth distance corresponding to the data of the grid farthest from the position of the subject vehicle 101 among the grids extracted at the time of the calculation processing of the road surface gradient.

According to the above-described embodiments heretofore, the following operation and effects are obtained.

(1) The external environment recognition apparatus 50 includes the LiDAR 5 as an in-vehicle detector that performs scanning irradiation of the irradiation light as an electromagnetic wave in the horizontal direction as a first direction within a field of view FOV and in the vertical direction as a second direction intersecting the first direction and that acquires, frame by frame, point cloud data including three-dimensional position information of detection points on the surface of objects around the subject vehicle 101, based on reflected waves from the objects; and the recognition unit 111 that recognizes, as road surface information, the road surface of the road RD, on which the subject vehicle 101 travels, and the three-dimensional object on the road on the basis of the point cloud data of each frame; the determination unit 113 that determines the interval of detection points required for the point cloud data of the next frame, on the basis of the predetermined size of the three-dimensional object determined in advance as a recognition target and a measurement distance from the subject vehicle 101 to the three-dimensional object based on the point cloud data; and the prediction unit 114 as a gradient prediction unit that, in a case where the maximum depth distance L as the farthest distance of the road surface in the traveling direction of the subject vehicle 101 recognized by the recognition unit 111 is shorter than the required depth distance N as the required distance based on the vehicle speed of the subject vehicle 101, predicts the gradient of the road surface that is not recognized by the recognition unit 111 on the basis of the road surface gradient map as gradient information associated with the map information in which the road RD is recorded, wherein when the gradient is predicted by the prediction unit 114, the determination unit 113 further determines the interval of detection points required for the point cloud data of the next frame, for a range from the maximum depth distance L to the required depth distance N, on the basis of the predetermined size of the three-dimensional object and the estimated distance from the subject vehicle 101 to the three-dimensional object, which is estimated from the map information and the gradient.

In general, since the viewing angle with respect to the recognition target is increased as the depth distance X is decreased, it is possible to recognize the recognition target even when the angular resolution is low. On the other hand, since the viewing angle with respect to the recognition target is decreased as the depth distance X is increased, high angular resolution is required for recognizing the recognition target. In the embodiment, the LiDAR 5 acquires the depth distance X to the road surface of the road RD in the traveling direction for each detection point, and the determination unit 113 determines the interval of the detection points required for the recognition unit 111 to recognize the three-dimensional object at the depth distance X. In addition, for the road surface where the depth distance X cannot be obtained by the LiDAR 5, the prediction unit 114 predicts the road surface on the basis of the road surface gradient map, and the determination unit 113 determines the interval of detection points required for the recognition unit 111 to recognize the above-described three-dimensional object at the depth distance X on the predicted road surface.

With this configuration, the interval of the detection points of the three-dimensional point cloud data used for the recognition processing by the recognition unit 111 is appropriately controlled by the determination unit 113, so that the total number of pieces of detection data used for the recognition processing can be suppressed. That is, the processing load of the processing unit 11 can be reduced without decreasing the recognition accuracy of the position or the size of the object or the like as the detection target of the external environment recognition apparatus 50.

In addition, in the embodiment, even in a case where the subject vehicle 101 travels on the road RD that is not included in the high-precision map information, the road RD to travel for the first time in a state in which the high-precision map information is not included, and the road RD that is changed to a mode different from the high-precision map information due to construction or the like, it is possible to determine the interval of the detection points required for the recognition unit 111 to recognize the three-dimensional object at each depth distance X while acquiring the depth distance X to the road surface of the road RD in the traveling direction for each detection point by using the LiDAR 5.

(2) The external environment recognition apparatus 50 further includes the position measurement unit 2 as a position detection unit that detects the position of the subject vehicle 101 on the basis of information from a satellite, and the prediction unit 114 as an adjustment unit that relatively shifts the position of the subject vehicle 101 detected by the position measurement unit 2 and the positions of the map information and the gradient information.

With this configuration, even in a case where an error is included in the current position of the subject vehicle 101 acquired using the position measurement unit 2 so that the position of the measurement data (data represented based on the position of the subject vehicle 101 detected by the position measurement unit 2) by the LiDAR 5 and the position of the data of the road surface gradient map do not align on the Xr axis (FIG. 8A), it is possible to substantially correct the error amount on the Xr axis (FIG. 8B). As a result, as compared with a case where the prediction unit 114 does not have a function as the adjustment unit, it is possible to accurately predict the gradient of the road surface that is not recognized by the recognition unit 111.

(3) In the external environment recognition apparatus 50, the gradient information is data created on the basis of the height Z of the road surface of the road RD measured by the LiDAR 5 of the subject vehicle 101 and/or another vehicle, and is data in which the position information of the road and the measured height Z of the road surface are associated and recorded at predetermined intervals. The prediction unit 114 as the adjustment unit searches, from the road in which the height Z of the road surface is recorded as the gradient information, for a section of a predetermined length (length corresponding to the size of the above grid) in which the difference in the height Z of the road surface from a comparison target section of a predetermined length (for example, 10 m), which includes the maximum depth distance L of the road RD based on the point cloud data, is equal to or less than the predetermined value, and shifts the position of the gradient information such that the searched section overlaps the comparison target section. More specifically, the position information of the gradient information is updated. In the search, the prediction unit 114 as the adjustment unit searches for the section having the predetermined length in which the sum of least squares of the height Z of the road surface at each predetermined interval included in the comparison target section and the height Z of the road surface at each predetermined interval based on the gradient information, indicated by the point cloud data, is minimized.

With this configuration, after the position of the road surface gradient map is relatively shifted, the actual measurement result (indicated by a solid line or double line in FIG. 8B) of the height Z of the road surface and the height Z (indicated by a dashed line in FIG. 8B) of the road surface from the road surface gradient map match, and the deviation ΔZ in the height direction is suppressed to a value equal to or less than the predetermined value. As a result, it is possible to accurately predict the gradient of the road surface that is not recognized by the recognition unit 111.

(4) In the external environment recognition apparatus 50, the determination unit 113 further determines the interval of detection points required for the point cloud data of the next frame as the scanning angular resolution of the irradiation light, and coarsens the scanning angular resolution within the field of view FOV of the LiDAR 5 as the scanning target of the irradiation light becomes farther than the required depth distance N.

With this configuration, for example, while higher recognition accuracy is secured in an area corresponding to the required depth distance N, the recognition accuracy is lowered in an area of the sky thereabove, and the total number of pieces of detection data used for the recognition processing by the recognition unit 111 can be suppressed. That is, it is possible to reduce the processing load of the processing unit 11 without decreasing the recognition accuracy of the position and size in the vertical direction of the object or the like as the recognition target of the external environment recognition apparatus 50.

(5) In the external environment recognition apparatus 50, the determination unit 113 further coarsens the scanning angular resolution within the field of view FOV of the LiDAR 5 as the scanning target of the irradiation light becomes closer than the required depth distance N.

With this configuration, it is possible to avoid providing more detection points than necessary for the recognition target close to the subject vehicle 101. That is, it is possible to reduce the processing load of the processing unit 11 without decreasing the recognition accuracy of the position and size in the horizontal direction of the object or the like as the recognition target of the external environment recognition apparatus 50.

The above embodiments may be modified into various modes. Hereinafter, modified examples will be described.

In the above-described embodiment, the example in which the external environment recognition apparatus 50 causes the LiDAR 5 to detect the road surface situation in the traveling direction of the subject vehicle 101 has been described. Instead of this, for example, the LiDAR 5 having an FOV in which 360 deg is detectable in the surroundings of the subject vehicle 101 may be provided, and the LiDAR 5 may be configured to detect the road surface situation of the entire surroundings of the subject vehicle 101.

The above embodiment can be combined as desired with one or more of the above modifications. The modifications can also be combined with one another.

According to the present invention, it is possible to reduce the load of processing of recognizing the external environment situation around the vehicle.

Above, while the present invention has been described with reference to the preferred embodiments thereof, it will be understood, by those skilled in the art, that various changes and modifications may be made thereto without departing from the scope of the appended claims.

What is claimed is:

1. An external environment recognition apparatus comprising:
an in-vehicle detector configured to perform scanning irradiation of electromagnetic waves in a first direction within a field of view and in a second direction intersecting the first direction, and to acquire, frame by frame, point cloud data including three-dimensional position information of detection points on surfaces of objects around a subject vehicle based on reflected waves from the objects; and
a microprocessor, wherein
the microprocessor is configured to perform:
recognizing, as road surface information, a road surface of a road on which the subject vehicle travels and a three-dimensional object on the road based on the point cloud data of each frame;
determining, based on a predetermined size of a predetermined three-dimensional object set as a recognition target and a measurement distance from the subject vehicle to the three-dimensional object based on the point cloud data, an interval of the detection points required for the point cloud data of a next frame; and
when a maximum depth distance of the road surface in a traveling direction of the subject vehicle recognized as the road surface is shorter than a required depth distance based on a vehicle speed of the subject vehicle, predicting a gradient of a portion of the road surface that is not recognized, based on gradient information associated with map information in which the road is recorded, wherein
when the gradient is predicted, the microprocessor is further configured to determine, for a range from the maximum depth distance to the required depth distance, the interval of the detection points required for the point cloud data of the next frame, based on the predetermined size of the predetermined three-dimensional object and an estimated distance from the subject vehicle to the three-dimensional object estimated from the map information and the gradient.

2. The external environment recognition apparatus according to claim 1, further comprising
a position detector configured to detect a position of the subject vehicle based on information from a satellite, wherein
the microprocessor is further configured to perform an adjustment for relatively shifting the position of the subject vehicle detected by the position detector and a position of the gradient information.

3. The external environment recognition apparatus according to claim 2, wherein
the gradient information is data created based on a height of the road surface of the road measured by the in-vehicle detector of the subject vehicle and/or another vehicle, the data being recorded in association with position information of the road and a measured height of the road surface, and
the microprocessor is configured to perform, in the adjustment, searching, from the road in which the height of the road surface is recorded as the gradient information, for a section having a predetermined length in which a difference in the height of the road surface from a comparison target section having the predetermined length and including the maximum depth distance of the road based on the point cloud data is equal to or less than a predetermined value, and to shift the position of the gradient information such that the searched section overlaps the comparison target section.

4. The external environment recognition apparatus according to claim 3, wherein
the gradient information is data in which the position information of the road and the height of the road surface are recorded in association with each other at predetermined intervals, and
the microprocessor is configured to perform, in the adjustment, searching for the section having the predetermined length in which a sum of least squares of the height of the road surface at each predetermined interval included in the comparison target section indicated by the point cloud data and the height of the road surface at each predetermined interval based on the gradient information is minimized.

5. The external environment recognition apparatus according to claim 1, wherein
the microprocessor is configured to perform, in the determination, determining the interval of the detection points required for the point cloud data of the next frame as a scanning angular resolution of the electromagnetic waves, and to coarsen the scanning angular resolution within the field of view of the in-vehicle detector as a scanning target of the electromagnetic waves becomes farther than the required depth distance.

6. The external environment recognition apparatus according to claim 5, wherein
the microprocessor is configured to perform, in the determination, coarsening the scanning angular resolution within the field of view of the in-vehicle detector as a scanning target of the electromagnetic waves becomes closer than the required depth distance.

7. The external environment recognition apparatus according to claim 1, wherein
the in-vehicle detector is a LiDAR.
